(19) United States
(12) Patent Application Publication
(10) Pub. No.: US 2024/0202802 A1
(43) Pub. Date: Jun. 20, 2024

(54) INTELLIGENT FOOD ORDER SELECTION AND FULFILLMENT PLATFORM

(71) Applicant: INTERNATIONAL BUSINESS MACHINES CORPORATION, Armonk, NY (US)

(72) Inventors: Hamid Majdabadi, Ottawa (CA); Jeremy R. Fox, Georgetown, TX (US); Su LIU, Austin, TX (US); Peng Hui Jiang, Beijing (CN)

(21) Appl. No.: 18/067,270

(22) Filed: Dec. 16, 2022

(51) Int. Cl. G06Q 30/0601; G06Q 10/087

(52) U.S. Cl. CPC G06Q 30/0635; G06Q 10/087

(57) ABSTRACT

Intelligent food order selection and fulfillment includes providing an electronic food item ordering platform through which users build and place electronic orders for food items, maintaining, for a user, a food item profile that includes preferences of the user relating to food item usage, receiving an electronic order for food items that includes perishable food items, receiving a planned schedule of use of the food items, identifying quality date requirements for the perishable food items based on the planned schedule of use, and determining a food item selection and order fulfillment strategy for selecting the perishable food items from a supplier food item inventory and fulfilling the electronic order, where the determining is based on the identified quality date requirements, known quality dates of the supplier food item inventory, and differences in cost, to the user, between interchangeable perishable food items with differing quality dates.

### BACKGROUND

Busy schedules and fast-paced lifestyles have led to the proliferation of online grocery ordering, in which a buyer builds and submits an order of groceries for fulfillment. Often the order is placed with a store that is located geographically near the buyer, store employees or other shoppers physically retrieve items of the order from store shelves, and the buyer either picks up the groceries or receives delivery of the order.

### SUMMARY

Shortcomings of the prior art are overcome and additional advantages are provided through the provision of a computer-implemented method. The method provides an electronic food item ordering platform through which users build and place electronic orders for food items. The method also maintains a food item profile for a user as part of the electronic food item ordering platform. The food item profile includes preferences of the user relating to food item usage. The method additional receives an electronic order for food items. The food items include perishable food items. The method additional receives a planned schedule of use of the plurality of food items. Further, the method identifies quality date requirements for the perishable food items of the electronic order based on the planned schedule of use. In addition, the method determines a food item selection and order fulfillment strategy for selecting the perishable food items from a supplier food item inventory and fulfilling the electronic order. The determining the food item selection and order fulfillment strategy is based on the identified quality date requirements, known quality dates of the supplier food item inventory, and differences in cost, to the user, between interchangeable perishable food items with differing quality dates.

Further, a computer system is provided that includes a memory and a processor in communication with the memory, wherein the computer system is configured to perform a method. The method Shortcomings of the prior art are overcome and additional advantages are provided through the provision of a computer-implemented method. The method provides an electronic food item ordering platform through which users build and place electronic orders for food items. The method also maintains a food item profile for a user as part of the electronic food item ordering platform. The food item profile includes preferences of the user relating to food item usage. The method additional receives an electronic order for food items. The food items include perishable food items. The method additional receives a planned schedule of use of the plurality of food items. Further, the method identifies quality date requirements for the perishable food items of the electronic order based on the planned schedule of use. In addition, the method determines a food item selection and order fulfillment strategy for selecting the perishable food items from a supplier food item inventory and fulfilling the electronic order. The determining the food item selection and order fulfillment strategy is based on the identified quality date requirements, known quality dates of the supplier food item inventory, and differences in cost, to the user, between interchangeable perishable food items with differing quality dates.

Yet further, a computer program product including a computer readable storage medium readable by a processing circuit and storing instructions for execution by the processing circuit is provided for performing a method. The method Shortcomings of the prior art are overcome and additional advantages are provided through the provision of a computer-implemented method. The method provides an electronic food item ordering platform through which users build and place electronic orders for food items. The method also maintains a food item profile for a user as part of the electronic food item ordering platform. The food item profile includes preferences of the user relating to food item usage. The method additional receives an electronic order for food items. The food items include perishable food items. The method additional receives a planned schedule of use of the plurality of food items. Further, the method identifies quality date requirements for the perishable food items of the electronic order based on the planned schedule of use. In addition, the method determines a food item selection and order fulfillment strategy for selecting the perishable food items from a supplier food item inventory and fulfilling the electronic order. The determining the food item selection and order fulfillment strategy is based on the identified quality date requirements, known quality dates of the supplier food item inventory, and differences in cost, to the user, between interchangeable perishable food items with differing quality dates.

Additional features and advantages are realized through the concepts described herein.

### BRIEF DESCRIPTION OF THE DRAWINGS

Aspects described herein are particularly pointed out and distinctly claimed as examples in the claims at the conclusion of the specification. The foregoing and other objects, features, and advantages of the disclosure are apparent from the following detailed description taken in conjunction with the accompanying drawings in which:

FIG. 1 depicts an example computing environment to incorporate and/or use aspects described herein;

FIG. 2 depicts an example conceptual diagram of components of a smart food order analyzer platform, in accordance with aspects described herein;

FIG. 3 depicts further details of an example smart food order selection/fulfillment module to incorporate and/or use aspects described herein; and

FIG. 4 depicts an example process for smart food order selection and fulfillment, in accordance with aspects described herein.

### DETAILED DESCRIPTION

Rising oil and gasoline prices along with labor issues in the freight sector cause supply-chain issues that contribute to the rise in food prices. This trend is predicted to continue, and for this and other reasons, solutions are desired that would offset some of these costs.

According to governmental regulations dictating food product labeling requirements, many food items are labeled with date(s) pertaining to food quality. Various types of dates and names for them exist, such as ‘sell by’, ‘use by’, ‘best by’, ‘best if used by’, ‘perishable date’, ‘expiration date’, and others. Such dates are collectively referred to herein as quality dates, and more generally indicate a recommended or mandated date related to quality of the food item.

In general, consumer-facing food retailers such as supermarkets and grocery stores try to ensure that their inventory is purchased before it expires. Shelves are often restocked daily with new or younger items, with the older products, nearer their quality dates, being placed at the front of the shelves and newer items placed toward the back of the shelves. Positioning items with nearer quality dates at the front of the shelves encourages consumers to purchase sooner-expiring items before the later-expiring items.

When an online grocery order is placed that includes perishable items such as dairy products, meats, fish, and fresh produce, it is often a time-sensitive order, the order placement and pick-up is mainly done by an individual, and the order is fulfilled by dedicated shoppers that navigate through a grocer's floorspace and pick items directly from grocery shelves.

Since consumers are aware that perishable items with later quality dates are placed toward the back of shelves as a favored approach by food retailers, they know to check the back of the shelves to find products with generally longer shelf lives, and such products may, in fact, be fresher. When shoppers shop for themselves in person, they may have the opportunity and desire to explore several shelf locations to find the product with the latest quality date, perceiving that to be the superior item. When consumers order online, however, for selection of the items by a third party, such option is not available. Meanwhile, the shoppers that pick items for online orders (often the food retailer's employees) have incentives to manually fill the orders as soon as possible, for example in order to maintain priority and satisfy delivery deadlines. Consequently, such shoppers often fetch the products at the front of the shelves since they are the most accessible. This may not present any issues when the quality dates are compatible with the customer's timeframe for using the items. However, sometimes the quality dates of fulfilled items are not compatible with the consumer's planned use of the items. Therefore, described herein are approaches and systems for intelligent food item order selection and fulfillment.

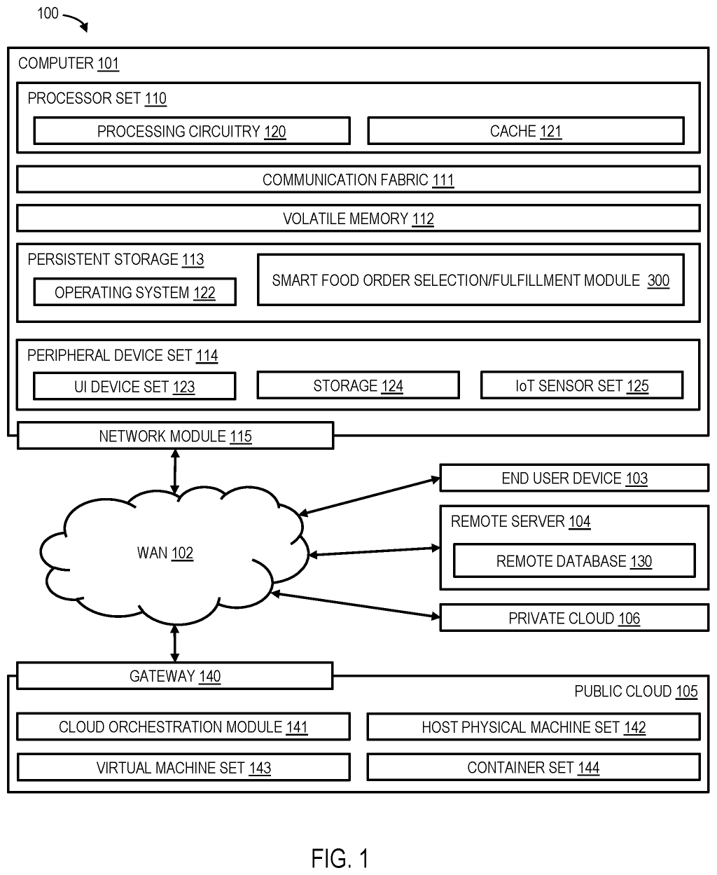

One or more embodiments described herein may be incorporated in, performed by and/or used by a computing environment, such as computing environment 100 of FIG. 1. As examples, a computing environment may be of various architecture(s) and of various type(s), including, but not limited to: personal computing, client-server, distributed, virtual, emulated, partitioned, non-partitioned, cloud-based, quantum, grid, time-sharing, cluster, peer-to-peer, mobile, having one node or multiple nodes, having one processor or multiple processors, and/or any other type of environment and/or configuration, etc. that is capable of executing process(es) that perform any combination of one or more aspects described herein. Therefore, aspects described and claimed herein are not limited to a particular architecture or environment.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as code of smart food order selection/fulfillment module 300. In addition to block 300, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 300, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 300 in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in block 300 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The computing environment described above in FIG. 1 is only one example of a computing environment to incorporate, perform, and/or use aspect(s) of the present invention. Other examples are possible. For instance, in one or more embodiments, one or more of the components/modules of FIG. 1 are not included in the computing environment and/or are not used for one or more aspects of the present invention. Further, in one or more embodiments, additional and/or other components/modules may be used. Other variations are possible.

In one aspect of this disclosure, systems and methods built on real-time data are provided to incorporate into current/new infrastructures features and functionality that enable food buyers to tap into an integrated set of powerful, new, and demanding AI-powered self-service shopping experiences. Thus, in one aspect, provided is an electronic food item ordering platform, such as a web site, web application, and/or mobile application, through which users build and place electronic orders for food items. While in some examples the users browse an inventory of available products and select items to build the shopping cart, in other examples grocery item(s) of an order might not be specifically identified by the user but instead inferred from a menu/schedule that the user provides. The system might be pre-configured by the user or otherwise to understand what items are needed for indicated dishes or other menu items, for instance, in which the platform automatically identifies the grocery items to fulfill the order in this case.

A smart perishable food order analyzer optimizes a consumer's online food order fulfillment by correlating a user profile, planned schedule(s) of food item use, and perishability factors (quality dates) to determine a food item selection and order fulfillment strategy for selecting perishable food items from a supplier's food item inventory and fulfilling the electronic order. The strategy extends beyond merely a supplier's desire to move food inventory that is nearing its quality dates. The strategy incorporates both selection of the specific food items to fulfill the order, as well as a fulfillment component as to when the delivery or deliveries of the food items of the order is/are to take place.

The strategy can provide cost savings and other benefits to food buyers (e.g., individual consumers, restaurants, etc.), suppliers (e.g., merchants, stores, manufacturers, etc.), and other supply-chain participants, and provide a significant positive environmental impact by helping to reduce food waste and landfill-related harmful gas production that results from food waste breakdown. For food producers, aspects will help avoid returns of products to producer/supplier outlets and enable them to manage shipment frequency based on real-time inventory movement with greater assurance that sold items will not be returned. For retailers, target consumers are expected to leverage aspects disclosure herein, leading to increased customer satisfaction due to cost savings and reduction in food waste. For consumers, aspects provide savings on food expenses and positive environmental impact, in addition to synchronization and optimization of consumer food menu schedules based on food quality dates, as described herein.

Initially, a user (interchangeably referred to as a “consumer” or “buyer” herein) can opt-in to the proposed solution to leverage its benefits. Users can be incentivized to opt-in, in some examples. Users can be existing customers, loyalty program members, account holders, etc. of the supplier (“seller”). Users could be individual consumers or other food retailers, like restaurants or school districts. Existing supplier customers may be prompted to participate, and potential new customers can be given an option to integrate with the solution. In addition, users who opt-in can selectively enable and disable features discussed herein.

Users who opt-in will establish a profile with various settings/preferences. Some preferences may be manually specified or set by the user, while some might be automatically determined, for instance based on user order history, and optionally modifiable by the user. Additionally or alternatively, some preferences might not be known or accessible to the user. Some preferences might specify cost saving thresholds or other settings that provide automatic approvals for certain actions related to submitted user orders, as is explained further herein. Thus, a consumer/user profile for related personalized user preferences is created, this shopping/food item profile is maintained for the user as part of the electronic food item ordering platform, and the profile can include preferences of the user relating to food item usage. The profile can also include ingredient or specific food item-related profile settings, for instance indications of food allergies, dietary restrictions, preferred diets, health-related dietary constraints, and specific ingredient preferences, among others. If the user is a restaurant, the type of restaurant/cuisine can be indicated. The profile can include consumer-specific brand preferences or any other preferences pertaining to types of products, health, and/or safety-related constraints, preferences, requirements, or considerations.

Consumer preference history can be collected, aggregated, and prepared for later and use by the system. The preference history of the consumer can include any relevant data, and optionally data gleaned from past input or selections by the user. A user might historically require a minimum (e.g., 10%) cost savings to approve certain order modifications described herein, or the user might routinely be unresponsive to outreach during certain hours of the day (i.e., restaurant rush hours), for example. The platform can auto-generate and maintain its own history about the consumer as it relates to past orders and interaction.

As part of the data collection to generate or augment the user's shopping profile, a component can learn user preferences by gathering information surrounding user engagement and interest with food, and store this in the user profile. Every aspect of user engagement with the platform can be considered, in some examples. This can inform additional dimensions for the user's profile. For security, user profiles can be secured/encrypted appropriately.

Some customer profiles can be linked where appropriate, for instance when multiple users are a part of a single-family/single outlet. It might be appropriate to merge, link, or otherwise associate these profiles to inform aggregated scores or preferences for that single outlet, or otherwise consider each linked profile when an order is received under any of the linked profiles. Preferences as to food category, brand, quality date requirements, and the like can be determined by considering each user of the linked profiles, for instance.

Thus, user profiles can store any desired preference data or other key information. Some example data includes, but is not limited to:
Participating members of a family, household, or other outlet;
Location and time of preferred food preparation—Location refers to a type of preparing establishment, for instance a restaurant versus an individual household. The time of preparation relates to specific anticipated timing of food item use, as food quality dates can sometimes be as granular as the time-of-day;
Daily (or other schedule) food menu;
Allergies and food preferences;
Medical conditions and temporary food restrictions;
Product quality date preferences for categories of food items—Some users have more restrictive preferences as to when they use food items than just quality dates. Some users might, for instance, prefer to use fish and seafood within a certain timeframe (e.g., two days) after purchase, regardless of what the quality date is of the food item, or no later than some timeframe (e.g., 24 hours) before the quality date expires. Such preferences can be overriding quality date requirements that override the manufacturer/supplier-provided quality date. Often times such preferences will be category-based, where the preference applies to all food items within a given category (e.g., meat, produce, dairy, bakery, canned items, meal type or time of day for use, etc.). In this manner, an identified quality date requirement for a perishable food item of the perishable food items of an order can be a function of (i) a quality date provided by a provider (e.g., manufacturer, supplier) of the food item together with (ii) a user preference, as indicated in the user profile, as to timing of use of the perishable food item relative to the quality date provided by the producer, where the user preference requires a date of actual use of the perishable food item to be an earlier date than the quality date provided by the producer. For items that are used on an ongoing basis, such as a container of milk that might be used throughout a week, the quality date requirement pursuant to the user's preference should be determined based on the last day of planned or expected use of the item. In other words, if the user's preference is to use milk up to, but no closer than, 3 days before its quality date, then the platform would determine that the quality date of the milk should be, at the earliest, three days after the planned last use of the milk. The user can therefore set preferences as to required timing of use of varying categories of food items.

Users use the platform in one aspect to build and submit electronic orders for food items, some or all of which could include perishable food items. The platform receives the orders and coordinates the fulfillment of those orders, in accordance with aspects described herein. As part of this, the platform selects food items from vendor inventory to satisfy the order. The platform can integrate a customer meal plan/menu as part of this by correlating a personal or retail (restaurant) planned menu to guide selection and provision of the food items to the customer. In examples, the platform receives such a planned schedule of use of the plurality of food items as an indication of when food items of the order are intended to be used. For an individual consumer, this might be a planned household menu for the week. For a restaurant customer, this could be a daily specials or other type of menu. Meal plans, menus, or other information indicative of the scheduled use of food items can be integrated with the user profile and/or uploaded when orders are placed.

Where the planned schedule of use includes a planned menu of dishes to be prepared and indications of when the dishes are to be prepared, this can assist the platform in identifying items compatible with the quality date requirements. With knowledge of when a particular perishable food item of the order is scheduled to be used, this indicates requirement(s) for the perishable food item, i.e., an earliest acceptable quality date for the perishable food item based on when the dish that incorporates that perishable food item is to be prepared. The determination of the food item selection and order fulfillment strategy can therefore select, from the supplier food item inventory, the perishable food items of lowest cost, to the user, that have quality dates that satisfy the identified quality date requirements for the perishable food items in the order. In other words, the schedule of use indicates minimum (earliest) quality dates for the perishable items and the strategy selects the items of lowest cost that have quality dates that satisfy the quality date requirements. As an example, a supplier might have 50 bunches of the same kind of parsley in stock, with some nearing their quality date (e.g., expiration) in 24 hours' time that is priced less than other bunches of parsley expiring in four days' time. If it is known that the customer is set to use the parsley tomorrow, then the sooner-expiring parsley at the lower price to the consumer can be used to fulfill the buyer's order.

Though explicit indications of scheduled food use may be typical, other information such as seasonal food availability, variety, and known special occasions/holidays can all be indicative of planned/scheduled food use.

Correlating user preferences with a schedule of use/preparation enables order optimization in terms of item selection and cost. The specific items needed and their intended date of use, together with user preferences, informs requirements as to by when each item is to be delivered and the minimum (earliest) quality date for each item. It also informs of possible points of flexibility and opportunity to reduce costs while staying within the parameters of the requirements. Collectively, this information provides a basis for the optimization of the item selection and order fulfillment strategy. If a particular seafood item is not to be used and served until Thursday, the item is not needed before then (i.e., delivery of the item can occur as late as when it is needed on Thursday) and the quality date of the fish can be that same day (Thursday), unless a user preference provides an override.

The strategy can therefore identify options to offer to the user that would result in lower costs to fulfill the order. For perishable items, the nearer they are to their quality date, the more likely they are to be offered at a reduced price since items past their quality date may be significantly harder or impossible for the seller to sell. The system can therefore identify options to offer the buyer perishable food items that are closer to their quality date in exchange for discounted prices. The buyer can set (or the system can automatically learn) thresholds or other preferences that might be used to automatically accept such options on behalf of the buyer. The buyer-user could opt-in to offers/acceptance of items in this ‘perishable’ category if a certain level of cost savings is met. Different thresholds corresponding to different categories of food items (meats, produce, etc.) can be set.

Additionally or alternatively, options for cost savings based on rearrangement/modification to the schedule of use can be identified, and the user can establish thresholds for offer and acceptance of such modifications. It may be that moving the user's intended date of use of a particular item would result in a significant enough cost savings because of the resulting change in quality date requirements for fulfilling the item. By way of specific example, moving a menu dish from Tuesday to Monday might enable the supplier to provide, as part of the order fulfillment, earlier-expiring, and therefore lower priced, food item(s) that go into making that dish. Extending this, the platform might identify that swapping two meals planned on different days might result in a net cost savings that is higher than a threshold the user has set for authorizing such swap. The authorization for the change therefore directly affects the strategy to select the items to fulfill the order. For instance, it might dictate that a specific carton of milk expiring tomorrow be selected from a group that includes milk expiring on other days.

The aggregate of user profile information, including category preferences, schedule of food item use, and consumption-based analytics is therefore integrated into the online platform to optimize order fulfillment, including food item health and freshness. The platform determines a food item selection and order fulfillment strategy for selecting the perishable food items from a supplier food item inventory and fulfilling the electronic order, which incorporates both selection of the specific food items and a fulfillment component, including when delivery is to be made. The determination of the food item selection and order fulfillment strategy is based, in part, on the identified quality date requirements informed by a schedule of use and/or the user profile/preferences. The determination of the strategy is also informed by known quality dates of the supplier (e.g., store, grocer, vendor, etc.) food item inventory. In this regard, the platform can include or have access to real-time, up-to-date information regarding the food item inventory, including quality dates of the inventory. This information can be entered manually by the supplier, determined automatically by optical, near-field, or other scanning of the products, or pulled from information provided by the wholesaler or other upstream supplier of the inventory. Further, differences in cost, to the user, between interchangeable perishable food items with differing quality dates can also be considered in the strategy determination. The platform can determine, for interchangeable items, which to provide as part of order fulfillment, and do so based on their costs. By “interchangeable” is meant (i) the same products with different quality dates (e.g., a loaf of Brand Y Seeded Rye Bread having a quality date Thursday versus the same product having a quality date of Monday) and/or (ii) substitute products that a user has indicated are acceptable substitutions, for instance Brand Y Unseeded Rye bread in place of Brand Y Seeded Rye bread, or Brand Z Wheat bread.

One emphasis of the strategy can be provision of soonest-expiring products that are nonetheless compatible with the schedule of use and the user's preferences as indicated by the user profile. The determination of the food item selection and order fulfillment strategy can therefore select from the supplier food item inventory the perishable food items, of the order, with the earliest quality days in exchange for a lower cost, to the user, to fulfill the electronic order.

As orders are received from a given user, applicable thresholds and other preference settings may be tagged to the order, and the platform can generate a compatible list of perishable food items to select for order fulfillment. Different candidate optimizations can be considered and compared in terms of their potential for cost savings. For instance, the platform could run through various candidate modifications to the schedule of food items use by rearranging which days or times different items are to be used/consumed, determining the impact such candidate modifications have on total cost to fulfill the order, and either presenting recommended modifications to the user or automatically making such modifications if pre-authorization has been given. Modifications can be beneficial to both the buyers and the sellers. From the standpoint of the seller, it enables them to identify food items that are expiring relatively soon and promote the sale/offer of sooner-expiring food items in order to reduce or eliminate food waste resulting from unsold, expired inventory. Buyers receive a benefit in the form of reduced costs for food expiring sooner that, nonetheless, is fresh when the buyer is to use the items.

In a specific example of a rescheduling aspect of the platform, determination of the food item selection and order fulfillment strategy includes identifying options to modify the planned schedule of use to reschedule when one or more of the dishes are to be prepared, and therefore when one or more of the perishable food items are to be used, such that the one or more perishable food items can be fulfilled with food items having respective quality dates closer to the dates of their use, and thereby reduce a cost, to the user, to fulfill the electronic order. At that point, identified option(s) can be presented to the user for selection to modify the planned schedule of use, receive a user-provided selection of an option, of the options, and fulfill the electronic order based on the selected option. Alternatively, an option could be automatically selected based on a preconfigured user preference of the user profile, and the electronic order could be fulfilled based on such automatic selection.

In connection with potential modifications to the planned schedule of use, the user profile can indicate a threshold for a minimum cost savings required to modify the planned schedule of use. In this case, the identifying of the options and presenting them to the user or automatically selecting one of them can identify those options that present cost savings of at least that threshold minimum cost savings.

When a planned schedule is modified based on set savings, the user can be notified ahead of the delivery so that the user is able to manage and plan accordingly. It is noted that modifications made to the schedule of use of one item might directly affect use of another item. For instance, a dish might incorporate several different ordered items, and therefore a movement of the dish from one time to another changes the schedule of use for each item used to prepare that dish. The quality dates of all such affected items are to be considered in any cost savings optimizations, meaning the effects of such modifications can be aggregated across all affected food items to produce an aggregate cost savings. It might even be the case that a modification results in the cost for one ingredient of the dish to be higher, however such increase might be outweighed by savings on other ingredients.

In some embodiments, the determination of the food item selection and order fulfillment strategy includes a determination to fulfill the electronic order in two (or more) fulfillments at different times. This can be based on the identified quality date requirements and the known quality dates of the supplier food item inventory, as well as on determining, from the cost differences between interchangeable perishable food items with differing quality dates, that a lower cost to the user would result from fulfilling the electronic order in such two (or more) fulfillments at the different times. An example to illustrate this is the following: Assume that a grocer's produce department receives inventory on Mondays and Thursdays and that a customer placed an order on Monday morning that includes a green pepper that the grocer has in stock that morning and that is set to expire 5 days later (on Saturday). Assume that the user is scheduled to use the pepper on Friday evening, though other items ordered are to be used later in the day on Monday, and therefore at least a portion of the order must be fulfilled on the day the order is placed. If fulfillment of the full order occurs later on Monday, then the price of the pepper will be at its highest since it is freshest. But since the pepper is not needed until Friday, there is no need for the pepper to arrive with the rest of the order on Monday evening. The platform could propose to defer fulfillment/delivery of the pepper to the user until sometime at late as Friday and offer an incentive to do so. The incentive could be an actual cost savings, such as free delivery on Monday and/or Friday, or actual lower cost for the pepper. Alternatively, the incentive could be the potential for a reduced price of the pepper. For instance, if by Thursday the pepper that previously arrived on Monday is still in inventory, the price to the consumer could be reduced on account of the pepper nearing the quality date of Saturday. If instead that pepper was sold during the week by the vendor, then the pepper to fulfill the order can be taken from the produce delivery arriving on Thursday, in which case the pepper to provide to the user on Friday is fresher (and at no higher a price) than what the user would have used if the pepper on the order been fulfilled for the user on Monday. There is an actual or potential chance for the user to pay less in this situation and/or receive a fresher food item while still guaranteeing the item will be available in time for use.

Thus, orders can be incentivized with. as examples, potential lower costs and/or free same day delivery if the consumer is willing to delay fulfillment of one or more order items in order to leverage additional saving based on perishable inventory arriving at a time closer to when it is intended to be used. In this manner, a supplier can incentivize a user to receive a portion of the order later than another portion of the order, which guarantees products at least as fresh as what the user would have received if fulfilled altogether. The user can opt-in for such delayed delivery option with the chance that the item(s) may go on-sale between a current time and a later time that is still before the scheduled use. The grocer can benefit because it can help plan for and guarantee a sale of perishable items in time, i.e., before their quality dates. In case there is no perishable discounted item that remains on the deferred delivery date, the grocer can simply satisfy the delivery from the new, fresher inventory, and the user received a fresher item than the user would otherwise have received.

The platform can also integrate quality date detectors into food item scanners or other devices, for instance those used by shoppers who pick the food items to fulfill orders. The detectors can provide quality date indications as part of a smart shopping cart that tracks and ensures compliance of the picked food items with the determined strategy. The platform can track, as the supplier's employee or other shopper shops for the items of the order, whether the strategy is being followed by using/leveraging sensors to detect, in real time as food items are fetched for fulfilling the electronic order, quality dates of the fetched food items, and checking the quality dates of the fetched food items against the food item selection and order fulfillment strategy to verify that the quality dates of the fetched food items satisfy the identified quality date requirements. Artificial intelligence (AI), augmented reality (AR), Internet of Things (IoT), near field communication (NFC), and/or optical character recognition (OCR)-based detection systems, as examples, can be integrated into a shopping cart and/or into mobile devices that the shoppers use to log picked items to enable the identifying and detecting of the quality dates. When a quality date conflicts with the strategy, for instance is in conflict with a user preference or conflicts with the planned schedule of use, the smart cart can notify the shopper-personnel to replace the item with a food item compliant/consistent with the strategy.

The platform can also provide notifications of food item receipt integrated with the user's profile and planned schedule of use. The user can manage the daily food schedule, receive confirmation of the online order, and receive reminders as to the food item ordered to be used for each scheduled meal. This can be useful for food items that last for multiple uses, for instance a package of eggs or carton of milk. If a planned schedule of use of the eggs includes use of the eggs over a series of days, the platform can provide to the user reminders of when and how much/many of the food item to use for each meal/dish preparation in order to remain consistent with the schedule. Such portioning can be helpful to ensure that the user uses a proper amount of the food item to ensure enough remains available for the other scheduled uses.

This can also be useful in situations where there are two (or more) of the same product that have different quality dates. The platform can remind the user to use the correct one at the appropriate time. To illustrate, a user might purchase two identical filets of fish—one for use on Monday and one for use on Wednesday. The strategy might identify one filet of fish with a quality date of Monday night to use for Monday's meal and another filet of fish with a quality date of Thursday to use for Wednesday's meal. In this situation, it is expected and desired for the user to use the prior-expiring filet for Monday's meal. Therefore, the platform can provide a clear identification of which filet the user is to use on Monday and which filet the user is to use on Wednesday. An example includes directing the grocer/supplier to tag the food items in a way that enables the user to distinguish, perhaps with the help of the platform, between the food items. The platform could even provide unique identifiers (printable stickers, RFID tags, etc.) for the supplier or user to use to tag ordered items to facilitate their identification to the user. Restaurants and other retailers that routinely carry a large quantity of each product may find this feature particularly useful in order to ensure that the retailer is identifying and using the proper portion (i.e., based on quality date) of each product on a daily basis.

In this manner, the platform can provide to the user electronic reminders of use of the food items of the grocery order, including identifications of which specific food items of the electronic order are to be used and when they are to be used. In situations where two or more perishable food items of the grocery order are a same product but with differing quality dates and for use at different times, the electronic reminders can identify which of the two or more perishable food items to use at each of the different times.

When an order has been picked consistent with the strategy, a delivery/pickup status can be updated to indicate that the order is now ready for the consumer. As part of this, the platform can provide a notification with individual status/confirmations for each food item that it is consistent with the strategy, including verifications of user preferences as to the food item.

The platform can also incorporate feedback and recommendations. For instance, the platform can integrate a personal feedback score of each order to optimize overall efficacy of the process and the effectiveness of a strategy determination model. The feedback can be from the users/buyers (e.g., individuals, restaurants, etc.). The more such users accept recommendations made by the platform, for instance schedule modifications or suggestions to accept food items nearer their quality dates, and provide feedback, the more the platform can give priority to those users in terms of future cost savings opportunities. Such loyalty/engagement programs and feedback participation enable users to become eligible or qualify for preference in allocating perishable items, and therefore realizing potential cost savings, when orders are placed.

In specific examples, feedback can be rewarded by the grocers/retailers when the users accept to participate in new initiatives for recommendations and food schedule modifications based on the supplier's on-site scheduled inventory deliveries. Users/customers can opt-into a grocer's recommendation to incorporate suggestions based on fresh food being delivered to the store. For instance, a user's order and preferences could be related to what has just recently been delivered to the store. This might inform possible food item substitutions (celery that is 4 days old for broccoli that has just been delivered), for instance. In this regard, the user might receive fresher (substitute) food for the same price. The user might receive discounts in exchange for taking suggested substitutions. In some examples, if the user opts-in to accept a platform recommendation and the user provides favorable feedback, the platform can be trained on this to know that it made a successful recommendation. The platform can learn over time based on this training (machine learning) and eventually expand/advertise to correlate inventory delivery of fresh food with targeted, order-specific recommendations that users can opt into. In a similar vein, users could opt-in to in-store recommendations for a meal similar to one that the user scheduled, provided that appropriate or comparable ingredients can be substituted and that it is in accordance with the user's profile preferences.

One basis for recommendations as to schedule modifications, meal substitutions, or food item substitutions can be an aggregated crowdsourced knowledge corpus, for instance a superset of data (e.g., data lake) to infuse the platform with crowdsourced recommendations at a broader level than the individual user-level. The crowdsourced knowledge corpus can be used for positive use case inclusion, in which certain buyer/seller food item exchanges that are successful in terms of user satisfaction with a particular product and limited or no waste on the part of the supplier be shared as part of the larger aggregated corpus. This may be especially useful with seasonal usages of various items that have shorter shelf lives and may be available at only certain times of the year. Locally grown seasonal produce is a specific example of such products.

The crowdsourced knowledge corpus can also be used for negative use case inclusion where examples of more significant waste of a particular product, group of foods, or the like, is identified and shared along with a context of the failure as part of the crowdsourced corpus, which could then enable suggestions to consumers and retailers as to how they might address such usage, for instance by encouraging them to consider and accept recommendations based on positive use cases.

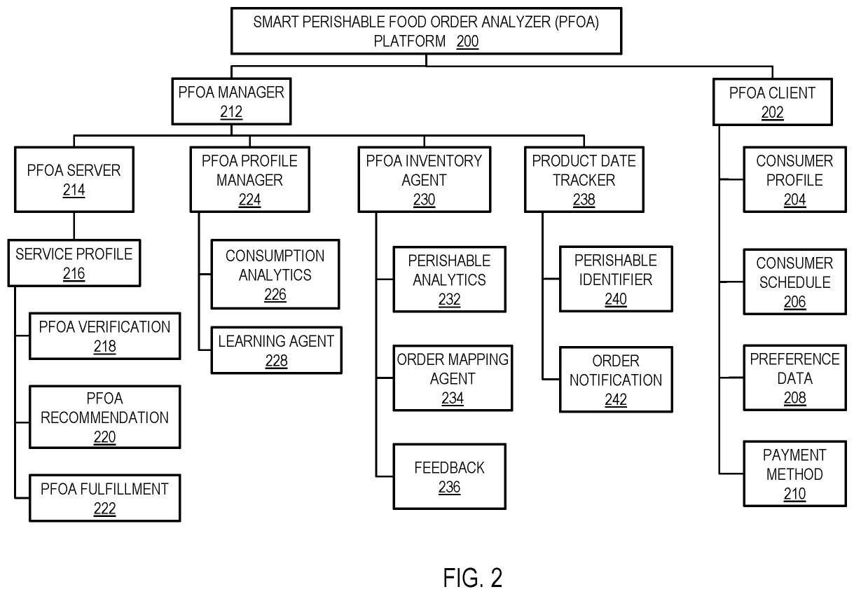

FIG. 2 depicts a conceptual diagram of components of a smart food order analyzer (PFOA) platform 200, in accordance with aspects described herein. The components of FIG. 2 could be implemented in, by, or as computer readable program code (e.g., instructions) and/or physical hardware to execute code/instructions, in examples. The platform encompasses client-side activity/access by PFOA client 202, for instance a mobile device that the user uses to build an order, and server-side activity by PFOA manager 212, for instance a service executing on one or more devices that receives input from non-client components and ensures, by coordinating and tracking records across non-client components, order fulfillment based on correct analytics, e.g., inventory, perishability, order preference, profile, and fulfillment. At the client side, the PFOA client 202 handles initial customer profile generation using customer profile component 204, indicates a planned schedule for food/meal preparation or use using customer schedule component 206, customizes customer preferences by way of the preference data 208, and configures a payment method 210. At the server side, the PFOA manager 212 uses PFOA server 214, implemented on a hybrid cloud platform for example, to manage order delivery. PFOA server 214 uses a service profile 216 to manage the order fulfillment processes. The service profile 216 leverages (i) PFOA verification component 218, which scans and verifies each order to ensure fulfillment is consistent with customers preferences/opt-ins, (ii) PFOA recommendation module 220, which makes perishable food substitution recommendations, and (iii) PFOA fulfillment module 222. The PFOA fulfillment module 222 cross-references orders with the user profile and preferences, taking into account recommendations for order item replacement or substitution to provide the best value to the user, as identified based on user profile. Fulfillment module 222 also finalizes and verifies (signs-off) details of the order. Once the order is finalized in this regard, PFOA fulfillment happens and the final order list is placed for pickup.

The PFOA manager 212 also uses PFOA profile manager 224, which is an integrated profile repository module that holds information about users from consumption analytics module 226, which scans through users' planned schedules of use/consumption times, and learning agent 228, which learns from consumer engagement and feedback/recommendations. The PFOA manager 212 also uses PFOA inventory agent 230, which is a module to track perishable inventory using perishable analytics component 232, which categorizes perishable items and their properties for different grocery departments, order mapping agent 234, which maps orders with non-inventory related information such as user profile to ensure delivery, pickup time, and contact detail is accurate, and feedback module 236, which collects feedback and offers rewards/prioritizations for customer participation. The PFOA manager 212 also uses product date tracker module 238 to track the quality dates of food item inventory, leverages perishable identifier component 240, which identifies and generates a list of perishable food items in inventory for different types of food items, and order notification component 242 that cross-references the user's product-related preferences with product-specific details and properties, e.g., inventory, perishability, and other product related details.

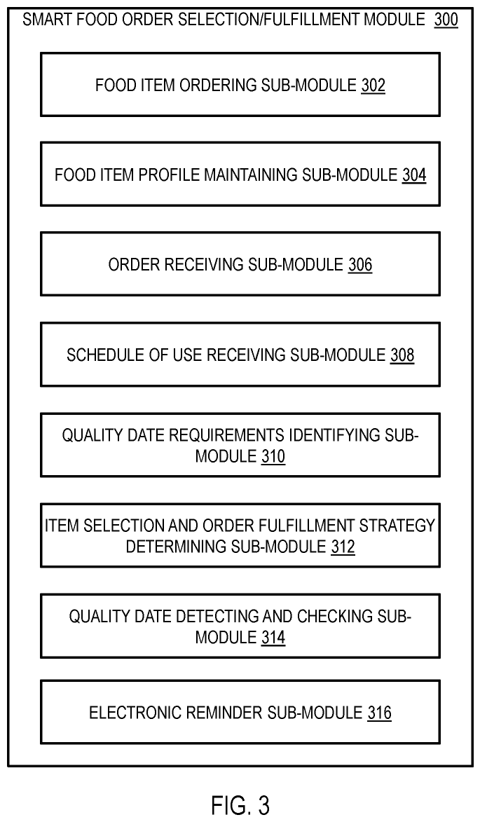

FIG. 3 depicts further details of an example smart food order selection/fulfillment module (e.g., smart food order selection/fulfillment module 300 of FIG. 1) to incorporate and/or use aspects described herein. In one or more aspects, smart food order fulfillment module 300) includes, in one example, various sub-modules to be used to perform aspects described herein. The sub-modules can be or include, e.g., computer readable program code (e.g., instructions) in computer readable media, e.g., persistent storage (e.g., persistent storage 113, such as a disk) and/or a cache (e.g., cache 121), as examples. The computer readable media may be part of a computer program product and may be executed by and/or using one or more computers or devices, and/or processor(s) or processing circuitry thereof, such as computer(s) 101, EUD 103, server 104, or computers of cloud 105/106 of FIG. 1, as examples.

Referring to FIG. 3, the smart food order selection/fulfillment module 300 includes electronic food item ordering sub-module (302), for example a grocery ordering website/application, through which users build and place electronic orders for food items, a food item profile maintaining sub-module (304) that maintains a food item profile for a user, the food item profile including (at least) preferences of the user relating to food item usage, an electronic order receiving sub-module (306) for receiving orders for food items, a planned schedule of use receiving sub-module (308) that receives indications from the user, for instance via an uploaded menu or other electronic information, about when the food items are intended to be used, a quality date requirements identifying sub-module (310) to determine quality date requirements of items of the order based on the planned schedule of use, a food item selection and order fulfillment strategy determining sub-module (312) that selects appropriate perishable food items from a supplier food item inventory for fulfilling the order, a quality date detecting and checking sub-module (314) that detects the quality dates of fetched food items and checks the quality dates of the fetched food items against the food item selection and order fulfillment strategy to verify that the quality dates of the fetched food items satisfy the identified quality date requirements, and an electronic reminder sub-module (316) that provides to the user electronic reminders of use of the food items of the grocery order, including identifications of which specific food items of the electronic order are to be used and when they are to be used.

In examples, the smart food order selection/fulfillment module 300 implements/includes, either in the sub-modules shown or with additional sub-modules, any of the components described with reference to FIG. 2 above or elsewhere herein.

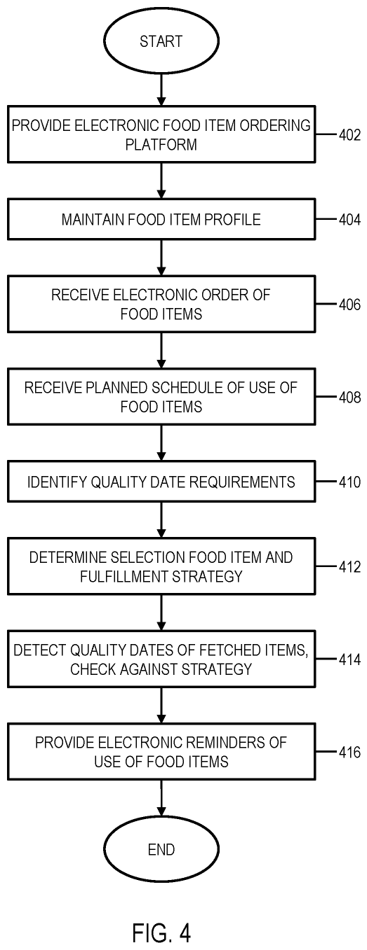

FIG. 4 depicts an example process for smart food order selection and fulfillment, in accordance with aspects described herein. The process may be executed, in one or more examples, by a processor or processing circuitry of one or more computers/computer systems, such as those described herein, and more specifically those described with reference to FIG. 1. In one example, code or instructions implementing the process(es) of FIG. 4 are part of a module, such as module 300. In other examples, the code may be included in one or more modules and/or in one or more sub-modules of the one or more modules. Various options are available.

The process of FIG. 4 includes providing (402) an electronic food item ordering platform through which users build and place electronic orders for food items. In examples, the providing includes providing, serving, hosting, or the like one or more servers that implement a grocery ordering website and/or software application. In examples, the application is a web application or service with client-side software and server-side software, for instance as described with reference to FIG. 2. The process of FIG. 4 additional maintains (404) a food item profile for a user as part of the electronic food item ordering platform. The food item profile incudes preferences of the user relating to food item usage. By “user” in this context is meant any user of the platform, which could include an account of an individual consumer or an account of a retailer, such as a restaurant or other retailer of food items that are supplied by a supplier of those food items.

The used can place, and therefore the platform receives (406), electronic food orders. An example electronic order is an order for a plurality of food items, at least some of which include perishable food items. The process receives (408) also a planned schedule of use of the plurality of food items. A planned schedule of use can be an indication from the user about when food items of the order are intended to be used. By way of specific example, the planned schedule of an individual consumer-user might be a plan of specific dinner meals to have each night of the upcoming week, while the planned schedule of a restaurant-user might be a menu and/or daily specials list indicative of the items to be available to customers at various times throughout the upcoming week.

The process identifies (410) quality date requirements for the perishable food items of the electronic order, and this identification is based on (at least) the planned schedule of use of items of the order. The identification can also be based on the user profile, for example. Further, the process determines (412) a food item selection and order fulfillment strategy, which is an optimization of the selection of food items of the user and of fulfilling the order with those food items. The strategy incorporates both selection of the specific food items to fulfill the order as well as fulfillment determinations, for instance when to deliver/supply all or parts of the order. Thus, the strategy is for selecting the perishable food items from a supplier food item inventory and fulfilling the electronic order, where the determination of the food item selection and order fulfillment strategy is based on the identified quality date requirements (identified at 410), as well as the quality dates of the supplier's food item inventory, which dates are known based on inventorying tracking or other inventory management. The strategy can also be based on differences in cost, to the user, between interchangeable perishable food items with differing quality dates. In this latter regard, the strategy determination can figure out, for items that are interchangeable, which to selected for the user and provide as part of the order fulfillment, and this can be based on their costs (and potentially other factors such as schedule of use modification). Interchangeable items are either two items that are the same product, such as two identical loaves of bread but with different quality dates, or substitute products that comport with user preferences as to substitutions, for instance Brandy X's Seeded Rye Bread as an acceptable substitute for Brand X's Seedless Rye Bread.

Interchangeable items with differing quality dates might be priced differently to the buyers, as generally a supplier wants to move products with earlier expiration dates to avoid food spoilage and therefore lost revenue. In light of this, the determination of the food item selection and order fulfillment strategy can select from the supplier food item inventory the perishable food items with the earliest quality days in exchange for a lower cost, to the user, to fulfill the electronic order. For interchangeable items, the strategy can identify the item in inventory that is least expensive to the user to fulfill the order yet comports with the user's quality date requirements for the item. For instance, the strategy might identify an apple expiring Tuesday at a lower cost than an apple expiring on Friday and identify the former apple to select and fulfill the order based on determining that the user plans to use the apple on Monday, prior to both quality dates.

In some embodiments, the planned schedule of use includes a planned menu of dishes to be prepared and indications of when those dishes are to be prepared. The dishes incorporate the perishable food items, and therefore the process can determine when the food items are to be used and potentially the quantities to use at each instance if it is something that is used multiple times. Some of the quality date requirements that are identified can therefore include, for at least some of the perishable food items, an earliest acceptable quality date for the perishable food item based on when a dish incorporating the perishable food item is to be prepared. The determination of the food item selection and order fulfillment strategy can select, from the supplier food item inventory, the perishable food items of lowest cost, to the user, with quality dates that satisfy the identified quality date requirements. In this regard, the planned schedule of use can be used to determine the earliest acceptable quality dates for perishable items.

In some embodiments, the earlier acceptable such date is the date/time when the item is actually going to be used. However, the user might have a preference as to the timing of item usage that is more strict than then quality date provided by a producer (supplier/manufacturer) of the item, and can therefore provide an override to the quality date. In this example, an identified quality date requirement for the perishable food item is a function of the quality date provided together with a user preference, as indicated in the user profile, as to timing of use of the perishable food item relative to the quality date provided by the producer. The user preference could require a date of use of the perishable food item to be an earlier date than the quality date provided by the producer. An example of this is a user preference that all meat products are to be used by no later than 2 days prior to the quality dates provided on the meat products. Such date (two days prior) should be taken as a last day of planned use in that case. It is noted that such overrides could work in the other direction, meaning that a user might accept use/consumption of certain perishable items after their quality date indicated. It is not uncommon for certain food items to have a quality date that does not necessarily mean the item cannot be consumed after that date. A user might indicate as a user preference a willingness to use/consume dry cereal items up to 10 days after their quality date, as an example.

It is seen that user timing preferences can be based on food item categories, where the user sets preferences as to required timing of use of varying categories of food items, for instance dairy, meat, produce, and/or bakery food items. Additionally, to the extent that the quality dates of products incorporate time-of-day elements, for instance that a particular piece of fish is to be used by 4:00 PM, user preferences for overrides can be specific for such time-of-day sensitive products. The user could indicate a preference that such products must be used at least 10 hours prior to their quality date/timing, or a preference that such produces can be up to 4 hours after their quality date/timing.

In an additional aspect, the determination of the food item selection and order fulfillment strategy includes identifying options to modify the planned schedule of use to reschedule when one or more of the dishes are to be prepared (and therefore when one or more of the perishable food items are to be used) such that the one or more perishable food items can be fulfilled with one or more food items having respective quality dates closer to dates of use and thereby reduce a cost, to the user, to fulfill the electronic order. In other words, the strategy can find and identify options that enable order fulfillment to provide food items that are scheduled for use closer to their expiration dates. The platform could present at least one of the options to the user for selection to modify the planned schedule of use, receive a selection of an option, of the options, from the user, and fulfilling the electronic order based on the selected option, and/or automatically select, based on a preconfigured user preference of the user profile, an option, of the options, to modify the planned schedule of use, and fulfill the electronic order based on that automatically selecting.

Whether a potential modification should be presented and/or automatically accepted can be based on threshold(s) indicated by the user profile. A threshold can be a threshold for minimum cost savings required to modify the planned schedule of use. The identification of the options can therefore identify the options that present cost savings of at least the minimum cost savings.

In some embodiments, the determination of the food item selection and order fulfillment strategy includes determining to fulfill the electronic order in multiple fulfillments at different times based on the identified quality date requirements and the known quality dates of the supplier food item inventory, and based further on determining, from the cost differences between interchangeable perishable food items with differing quality dates, that a lower cost to the user would result from fulfilling the electronic order in the multiple fulfillments at different times. As an example, it might be known that a meat department offers discounts on items that are within two days of their quality dates and that some meat inventory of the grocer is nearing this date. The strategy might defer selection and fulfillment of a purchased meat item that is not to be used for several days in this case on account of the anticipated cost savings that would result. The platform can dictate that fulfillment of the meat item in this case be deferred until the later time so that the customer receives the discounted price. In addition or the alternative to lower cost of the item itself, the platform could prompt deferment by incentivizing a later fulfillment in other ways, for instance in the form of free delivery, reward coupons, or discounts on other products.

As an enhancement, a process can use (414) sensors to detect, in real time as food items are fetched for fulfilling the electronic order, quality dates of the fetched food items, and check the quality dates of the fetched food items against the food item selection and order fulfillment strategy to verify that the quality dates of the fetched food items satisfy the identified quality date requirements.

As yet another enhancement, a reminder feature can remind the user when to use the purchased items. The process can therefore provide (416) to the user electronic reminders of use of the plurality of food items of the grocery order, including identifications of which specific food items of the electronic order are to be used and when they are to be used. This can be particularly useful when there are two or more of the same product that have different quality dates and are to be used at different times. In these cases where two or more perishable food items of the grocery order are a same product with differing quality dates and for use at different times, the electronic reminders can identify which of the two or more perishable food items to use at each of those different times.

In another example embodiment, a process: (i) maintains a food item profile for a user as part of an electronic food item ordering platform, the food item profile including a planned schedule of use of a plurality of perishable food items, (ii) correlates the planned schedule of use of the plurality of perishable food items with quality dates of perishable food items in a supplier food item inventory based on quality date requirements ascertained from at least the planned schedule of use, and (iii) identifies, from the correlating, which food items of the food items in the supplier food item inventory to select and fulfill a grocery order for the plurality of perishable food items, where the identifying selects which item, of a group of interchangeable perishable food items in the supplier food item inventory having different quality dates, to use in fulfilling a perishable food item of the plurality of perishable food items.

In another example embodiment, a process (i) receives an electronic order for a plurality of food items, the plurality of food items comprising perishable food items, (ii) identifies quality date requirements for the perishable food items of the electronic order, the quality date requirements being requirements for latest acceptable quality dates of items to fulfill the perishable food items of the electronic order, and, (iii) based on identifying the quality date requirements and on known quality dates of supplier food item inventory, performs (a) substituting, in place of a first perishable food item of the perishable food items of the electronic order, a second perishable food item, the second perishable food item being indicated as an acceptable substitute in user preferences for a user placing the electronic order and/or (b) recommending that fulfillment of the electronic be performed in a plurality of fulfillments at different times.

In yet another example embodiment, a process, based on selection and placement of a food item into a physical shopping container, (i) detects, with one or more sensors, a quality date of the food item, (ii) checks the detected quality date against a strategy for food item selection and order fulfillment, the strategy being based on quality date requirements as indicated by (a) a user profile and (b) indications of planned use of the food item by the user, where the checking determines based on the quality date of the food item whether the food item is compatible with the strategy, and (iii) based on determining that the food item is incompatible with the strategy, electronically prompts a shopper to replace the food item and identifies for the shopper an interchangeable food item that is available in a supplier food item inventory for selection in place of the replaced food item.

Although various embodiments are described above, these are only examples.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description, but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A computer-implemented method comprising:
providing an electronic food item ordering platform through which users build and place electronic orders for food items;
maintaining a food item profile for a user as part of the electronic food item ordering platform, the food item profile comprising preferences of the user relating to food item usage;
receiving an electronic order for a plurality of food items, the plurality of food items comprising perishable food items;
receiving a planned schedule of use of the plurality of food items;
identifying quality date requirements for the perishable food items of the electronic order based on the planned schedule of use;
determining a food item selection and order fulfillment strategy for selecting the perishable food items from a supplier food item inventory and fulfilling the electronic order, wherein the determining the food item selection and order fulfillment strategy is based on the identified quality date requirements, known quality dates of the supplier food item inventory, and differences in cost, to the user, between interchangeable perishable food items with differing quality dates.

2. The method of claim 1, wherein the planned schedule of use comprises a planned menu of dishes to be prepared and indications of when the dishes are to be prepared, the dishes incorporating the perishable food items, wherein the identified quality date requirements indicate, for each of the perishable food items, an earliest acceptable quality date for the perishable food item based on when a dish incorporating the perishable food item is to be prepared, and wherein the determining the food item selection and order fulfillment strategy selects, from the supplier food item inventory, the perishable food items of lowest cost, to the user, with quality dates that satisfy the identified quality date requirements.

3. The method of claim 2, wherein the determining the food item selection and order fulfillment strategy selects from the supplier food item inventory the perishable food items with the earliest quality days in exchange for a lower cost, to the user, to fulfill the electronic order.

4. The method of claim 2, wherein the determining the food item selection and order fulfillment strategy comprises:
identifying options to modify the planned schedule of use to reschedule when one or more of the dishes are to be prepared, and therefore when one or more of the perishable food items are to be used, such that the one or more perishable food items can be fulfilled with one or more food items having respective quality dates closer to dates of use and thereby reduce a cost, to the user, to fulfill the electronic order; and
performing one selected from the group consisting of:
presenting at least one of the options to the user for selection to modify the planned schedule of use, receiving a selection of an option, of the options, from the user, and fulfilling the electronic order based on the selected option; and
automatically selecting, based on a preconfigured user preference of the user profile, an option, of the options, to modify the planned schedule of use, and fulfilling the electronic order based on the automatically selecting.

5. The method of claim 4, wherein the user profile indicates a threshold for minimum cost savings required to modify the planned schedule of use, and wherein the identifying identifies the options that present cost savings of at least the minimum cost savings.

6. The method of claim 1, wherein an identified quality date requirement for a perishable food item of the perishable food items is a function of a quality date provided by a producer of the food item together with a user preference, as indicated in the user profile, as to timing of use of the perishable food item relative to the quality date provided by the producer, wherein the user preference requires a date of use of the perishable food item to be an earlier date than the quality date provided by the producer.

7. The method of claim 6, wherein the user sets preferences as to required timing of use of varying categories of food items, the varying categories comprising at least one selected from the group consisting of dairy food items and meat food items.

8. The method of claim 1, wherein the determining the food item selection and order fulfillment strategy comprises determining to fulfill the electronic order in a plurality of fulfillments at different times based on the identified quality date requirements and the known quality dates of the supplier food item inventory, and based further on determining, from the cost differences between interchangeable perishable food items with differing quality dates, that a lower cost to the user would result from fulfilling the electronic order in a plurality of fulfillments at different times.

9. The method of claim 8, further comprising offering, to the user, an incentive to fulfill the electronic order in the plurality of fulfillments.

10. The method of claim 1, further comprising:
using sensors to detect, in real time as food items are fetched for fulfilling the electronic order, quality dates of the fetched food items; and
checking the quality dates of the fetched food items against the food item selection and order fulfillment strategy to verify that the quality dates of the fetched food items satisfy the identified quality date requirements.

11. The method of claim 1, further comprising providing to the user electronic reminders of use of the plurality of food items of the grocery order, including identifications of which specific food items of the electronic order are to be used and when they are to be used, wherein two or more perishable food items of the grocery order are a same product with differing quality dates and for use at different times, and wherein the electronic reminders identify which of the two or more perishable food items to use at each of the different times.

12. A computer system comprising:
a memory; and
a processor in communication with the memory, wherein the computer system is configured to perform a method comprising:
providing an electronic food item ordering platform through which users build and place electronic orders for food items;
maintaining a food item profile for a user as part of the electronic food item ordering platform, the food item profile comprising preferences of the user relating to food item usage;
receiving an electronic order for a plurality of food items, the plurality of food items comprising perishable food items;
receiving a planned schedule of use of the plurality of food items;
identifying quality date requirements for the perishable food items of the electronic order based on the planned schedule of use;
determining a food item selection and order fulfillment strategy for selecting the perishable food items from a supplier food item inventory and fulfilling the electronic order, wherein the determining the food item selection and order fulfillment strategy is based on the identified quality date requirements, known quality dates of the supplier food item inventory, and differences in cost, to the user, between interchangeable perishable food items with differing quality dates.

13. The computer system of claim 12, wherein the planned schedule of use comprises a planned menu of dishes to be prepared and indications of when the dishes are to be prepared, the dishes incorporating the perishable food items, wherein the identified quality date requirements indicate, for each of the perishable food items, an earliest acceptable quality date for the perishable food item based on when a dish incorporating the perishable food item is to be prepared, and wherein the determining the food item selection and order fulfillment strategy selects, from the supplier food item inventory, the perishable food items of lowest cost, to the user, with quality dates that satisfy the identified quality date requirements.

14. The computer system of claim 13, wherein the determining the food item selection and order fulfillment strategy comprises:
identifying options to modify the planned schedule of use to reschedule when one or more of the dishes are to be prepared, and therefore when one or more of the perishable food items are to be used, such that the one or more perishable food items can be fulfilled with one or more food items having respective quality dates closer to dates of use and thereby reduce a cost, to the user, to fulfill the electronic order; and
performing one selected from the group consisting of:
presenting at least one of the options to the user for selection to modify the planned schedule of use, receiving a selection of an option, of the options, from the user, and fulfilling the electronic order based on the selected option; and
automatically selecting, based on a preconfigured user preference of the user profile, an option, of the options, to modify the planned schedule of use, and fulfilling the electronic order based on the automatically selecting.

15. The computer system of claim 12, wherein an identified quality date requirement for a perishable food item of the perishable food items is a function of a quality date provided by a producer of the food item together with a user preference, as indicated in the user profile, as to timing of use of the perishable food item relative to the quality date provided by the producer, wherein the user preference requires a date of use of the perishable food item to be an earlier date than the quality date provided by the producer.

16. The computer system of claim 12, wherein the determining the food item selection and order fulfillment strategy comprises determining to fulfill the electronic order in a plurality of fulfillments at different times based on the identified quality date requirements and the known quality dates of the supplier food item inventory, and based further on determining, from the cost differences between interchangeable perishable food items with differing quality dates, that a lower cost to the user would result from fulfilling the electronic order in a plurality of fulfillments at different times.

17. A computer program product comprising:
a computer readable storage medium readable by a processing circuit and storing instructions for execution by the processing circuit for performing a method comprising:
providing an electronic food item ordering platform through which users build and place electronic orders for food items;
maintaining a food item profile for a user as part of the electronic food item ordering platform, the food item profile comprising preferences of the user relating to food item usage;
receiving an electronic order for a plurality of food items, the plurality of food items comprising perishable food items;
receiving a planned schedule of use of the plurality of food items;
identifying quality date requirements for the perishable food items of the electronic order based on the planned schedule of use;
determining a food item selection and order fulfillment strategy for selecting the perishable food items from a supplier food item inventory and fulfilling the electronic order, wherein the determining the food item selection and order fulfillment strategy is based on the identified quality date requirements, known quality dates of the supplier food item inventory, and differences in cost, to the user, between interchangeable perishable food items with differing quality dates.

18. The computer program product of claim 17, wherein the planned schedule of use comprises a planned menu of dishes to be prepared and indications of when the dishes are to be prepared, the dishes incorporating the perishable food items, wherein the identified quality date requirements indicate, for each of the perishable food items, an earliest acceptable quality date for the perishable food item based on when a dish incorporating the perishable food item is to be prepared, and wherein the determining the food item selection and order fulfillment strategy selects, from the supplier food item inventory, the perishable food items of lowest cost, to the user, with quality dates that satisfy the identified quality date requirements.

19. The computer program product of claim 18, wherein the determining the food item selection and order fulfillment strategy comprises:
identifying options to modify the planned schedule of use to reschedule when one or more of the dishes are to be prepared, and therefore when one or more of the perishable food items are to be used, such that the one or more perishable food items can be fulfilled with one or more food items having respective quality dates closer to dates of use and thereby reduce a cost, to the user, to fulfill the electronic order; and
performing one selected from the group consisting of:
presenting at least one of the options to the user for selection to modify the planned schedule of use, receiving a selection of an option, of the options, from the user, and fulfilling the electronic order based on the selected option; and
automatically selecting, based on a preconfigured user preference of the user profile, an option, of the options, to modify the planned schedule of use, and fulfilling the electronic order based on the automatically selecting.

20. The computer program product of claim 17, wherein an identified quality date requirement for a perishable food item of the perishable food items is a function of a quality date provided by a producer of the food item together with a user preference, as indicated in the user profile, as to timing of use of the perishable food item relative to the quality date provided by the producer, wherein the user preference requires a date of use of the perishable food item to be an earlier date than the quality date provided by the producer.
